(19) United States
(12) Patent Application Publication
(10) Pub. No.: US 2016/0246721 A1
(43) Pub. Date: Aug. 25, 2016

(54) ROLE BASED CACHE COHERENCE BUS TRAFFIC CONTROL

(71) Applicant: QUALCOMM Incorporated, San Diego, CA (US)

(72) Inventors: Phil Joseph BOSTLEY, III, Boulder, CO (US); Jaya Prakash Subramaniam GANASAN, Youngsville, NC (US)

(21) Appl. No.: 14/626,913

(22) Filed: Feb. 19, 2015

(51) Int. Cl. G06F 12/08; G06F 9/46; G06F 9/455

(52) U.S. Cl. CPC G06F 12/0828; G06F 9/45558; G06F 9/466; G06F 12/0811; G06F 2212/622; G06F 2009/45587; G06F 2212/152; G06F 2212/283

(57) ABSTRACT

A method for controlling cache snoop and/or invalidate coherence traffic for specific caches based on transaction attributes is described. A memory management unit (MMU) determines one or more transaction attributes for a cache coherence transaction from a requesting processor. A routing module identifies a cachability domain and/or shareability domain based on the transaction attributes and routes the cache coherence transaction to one or more caches in the cachability domain and/or shareability domain. Instead of coherence traffic being routed to all caches on a coherence bus, coherence traffic is selectively routed based on transaction attributes such as an address space identifier (ASID), a virtual machine identifier (VMID), a secure bit (NS), a hypervisor identifier (HYP), etc.

### FIELD OF DISCLOSURE

Aspects of the present disclosure relate generally to processors, and more particularly, to cache coherence bus traffic control based on a processor's role.

### BACKGROUND

Modern computer systems use caches to improve processor memory latency and throughput of slower memory devices, such as double data rate synchronous dynamic random-access memory (DDR SDRAM). The caches are either shared between multiple processors or dedicated to a subset of the processors. Processors that share work observe a common model of system memory such that the effects of read and write operations on memory are observed in a consistent and defined order. Unless the caches are kept coherent, an opportunity exists for the memory model to be violated and the effects of memory operations to be incorrectly observed.

Cache coherence transactions are transactions that observe a protocol used among caches that ensure that the caches remain coherent and that the rules for the memory model are followed. Two conventional protocol are a snoop mechanism and an invalidate mechanism.

In the snoop mechanism, on write operations to any given cache, a cache controller verifies that copies of a data file that are returned to other caches are updated. In the invalidate mechanism, on write operations to any given cache, the cache controller verifies that copies of a data file do not exist in other caches.

With the advent of highly integrated computer systems combining processor virtualization, heterogeneous computing, and systems with a large number of processors and caches, each of the processors within the computer system may perform a variety of tasks in a time sliced or simultaneous manner. Each of these tasks serves a different role within the computer system, thus using different resources.

In massively parallel computer systems that virtualize multiple operating systems, a subset of processors and their associated caches are assigned to each individual operating system. This creates an overlapping set of caches that should remain coherent.

For example, in heterogeneous computer systems Graphic Processing Units (GPUs) may be performing both standalone graphics tasks that do not benefit from cache coherence with a host Central Processing Unit (CPU) in addition to heterogeneous computing tasks where coherence is needed. Multiple Central Processing Units (CPUs) can also introduce disjoint sets of caches that should maintain coherence on a task-by-task basis. In single processor computer systems, security requirements may require that some caches be used for secure tasks and other caches be used for non-secure tasks.

As computer systems get larger and more integrated, the set of caches that must participate in traditional “all or nothing” cache coherence protocols in which all caches are checked for the requested data file, increases proportionally. There also is a concomitant increase in bandwidth, energy use, heat generation, and latency associated with those coherence transactions. In mobile systems in particular, but applicable to all computer systems, the costs associated with the increase in bandwidth, energy use, heat generation, and latency associated with coherence transactions are undesirable. Thus, improved mechanisms for arbitrating cache requests are needed.

### SUMMARY

One implementation of the technology described herein is directed to a method for routing a coherence request to one or more caches in a computing system, the method comprising: determining one or more transaction attributes for a cache coherence transaction from a requesting processor; identifying a cachability domain and/or shareability domain based on the transaction attributes; and routing the cache coherence transaction to one or more caches in the cachability domain and/or shareability domain.

Another implementation of the technology described herein is directed to an apparatus for routing a coherence request to one or more caches in a computing system, the apparatus comprising: a memory management unit (MMU) configured to determine one or more transaction attributes for a cache coherence transaction from a requesting processor; and a routing module configured to: identify a cachability domain and/or shareability domain based on the transaction attributes and to route the cache coherence transaction to one or more caches in the cachability domain and/or shareability domain.

Another implementation is directed to an apparatus for routing a coherence request to one or more caches in a computing system, the apparatus comprising: means for determining one or more transaction attributes for a cache coherence transaction from a requesting processor; means for identifying a cachability domain and/or shareability domain based on the transaction attributes; and means for routing the cache coherence transaction to one or more caches in the cachability domain and/or shareability domain.

Still another implementation is directed to a computer-readable storage medium including information that, when accessed by a machine, cause the machine to perform operations for routing a coherence request to one or more caches in a computing system, the operations comprising: determining one or more transaction attributes for a cache coherence transaction from a requesting processor; identifying a cachability domain and/or shareability domain based on the transaction attributes; and routing the cache coherence transaction to one or more caches in the cachability domain and/or shareability domain.

This Summary is submitted with the understanding that it will not be used to interpret or limit the scope or meaning of the claims. This Summary is not intended to identify key features or essential features of the claimed subject matter, nor is it intended to be used as an aid in determining the scope of the claimed subject matter.

### BRIEF DESCRIPTION OF THE DRAWINGS

The accompanying drawings are presented to aid in the description of implementations of the technology described herein and are provided solely for illustration of the implementations and not limitation thereof.

FIG. 1 is a block diagram of an example environment suitable for implementing role based cache coherence traffic control according to one or more implementations of the technology described herein.

FIG. 2 illustrates the Graphics Processing Unit (GPU) depicted in FIG. 1 in more detail according to one or more implementations of the technology described herein.

FIG. 3 illustrates the Digital Signal Processor (DSP) depicted in FIG. 1 in more detail according to one or more implementations of the technology described herein.

FIG. 4 illustrates one of the Central Processing Units (CPUs) depicted in FIG. 1 in more detail according to one or more implementations of the technology described herein.

FIG. 5 illustrates another one of the Central Processing Units (CPUs) depicted in FIG. 1 in more detail according to one or more implementations of the technology described herein.

FIG. 6 illustrates another one of the Central Processing Units (CPUs) depicted in FIG. 1 in more detail according to one or more implementations of the technology described herein.

FIG. 7 illustrates another one of the Central Processing Units (CPUs) depicted in FIG. 1 in more detail according to one or more implementations of the technology described herein.

FIG. 8 is an example flow diagram illustrating a method for implementing role based cache coherence traffic reduction according to one or more implementations of the technology described herein.

FIG. 9 is a block diagram illustrating a wireless device configured according to one or more implementations of the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

In general, the subject matter disclosed herein is directed to controlling cache snoop and invalidate coherence traffic for specific caches based on transaction attributes. The transaction attributes identify the particular role of a processor initiating a coherence transaction within a computing system. Instead of coherence traffic being routed to all caches on a coherence bus, implementations of the technology described herein route coherence traffic based on the roles of the requesting processors as defined by the transactions attributes.

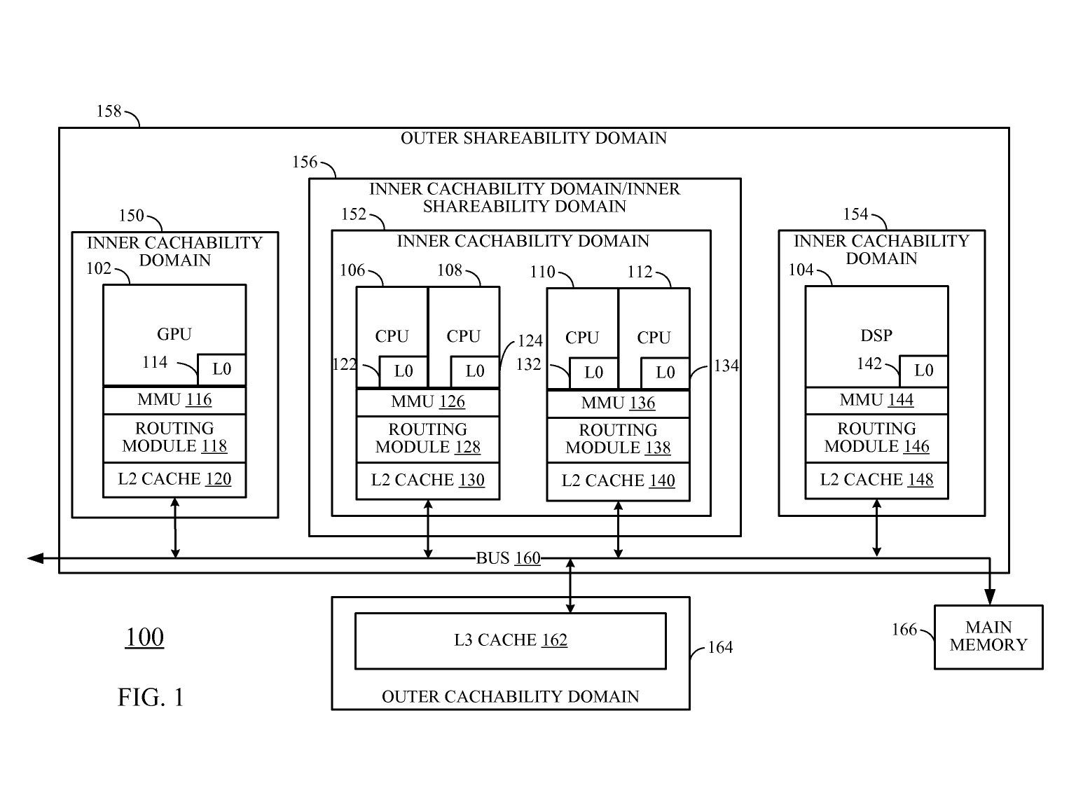

FIG. 1 is a block diagram of an example environment 100 suitable for implementing role based cache coherence bus traffic control according to one or more implementations of the technology described herein. The illustrated environment 100 includes a Graphics Processing Unit (GPU) 102, a Digital Signal Processor (DSP) 104, a Central Processing Unit (CPU) 106, a Central Processing Unit (CPU) 108, a Central Processing Unit (CPU) 110, and a Central Processing Unit (CPU) 112 coupled as illustrated.

The illustrated Graphics Processing Unit (GPU) 102 includes a Level 0 cache 114. The illustrated Graphics Processing Unit (GPU) 102 is coupled to a memory management unit (MMU) 116, a routing module 118, and a Level 2 cache 120.

The illustrated Central Processing Unit (CPU) 106 includes a Level 0 cache 122. The illustrated Central Processing Unit (CPU) 108 includes a Level 0 cache 124. The Central Processing Unit (CPU) 106 and the Central Processing Unit (CPU) 108 are coupled to a memory management unit (MMU) 126, a routing module 128, and a Level 2 cache 130.

The illustrated Central Processing Unit (CPU) 110 includes a Level 0 cache 132. The illustrated Central Processing Unit (CPU) 112 includes a Level 0 cache 134. The Central Processing Unit (CPU) 110 and the Central Processing Unit (CPU) 112 are coupled to a memory management unit (MMU) 136, a routing module 138, and a Level 2 cache 140.

The illustrated Digital Signal Processor (DSP) 104 includes a Level 0 cache 142. The illustrated Digital Signal Processor (DSP) 104 is coupled to a memory management unit (MMU) 144, a routing module 146, and a Level 2 cache 148.

The illustrated Graphics Processing Unit (GPU) 102, the Level 0 cache 114, the memory management unit (MMU) 116, the routing module 118, and the Level 2 cache 120 are associated with an inner cachability domain 150.

The illustrated Central Processing Unit (CPU) 106, the Central Processing Unit (CPU) 108, the Level 0 cache 122, the Level 0 cache 124, the memory management unit (MMU) 126, the routing module 128, and the Level 2 cache 130 are associated with an inner cachability domain 152. The illustrated Central Processing Unit (CPU) 110, the Central Processing Unit (CPU) 112, the Level 0 cache 132, the Level 0 cache 134, the memory management unit (MMU) 136, the routing module 138, and the Level 2 cache 140 also are associated with the inner cachability domain 152.

Being in the inner cachability domain 152 means that the Central Processing Unit (CPU) 106 and the Central Processing Unit (CPU) 108 can share their Level 2 cache 130 with the Central Processing Unit (CPU) 110 and the Central Processing Unit (CPU) 112. Likewise, the Central Processing Unit (CPU) 110 and the Central Processing Unit (CPU) 112 can share their Level 2 cache 140 with the Central Processing Unit (CPU) 106 and the Central Processing Unit (CPU) 108.

The illustrated Digital Signal Processor (DSP) 104, the Level 0 cache 142, the memory management unit (MMU) 144, the routing module 146, and the Level 2 cache 148 are associated with an inner cachability domain 154. Inner cachability is indicated by a bit being set in a page table for the page in the cache that is to be accessed.

The inner cachability domain 152 is associated with an inner cachability domain/inner shareability domain 156. Inner shareability is indicated by a bit in a page table for the page in the cache that is to be accessed.

The inner cachability domain 150, the inner cachability domain 154, and the inner cachability domain/inner shareability domain 156 are associated with an outer shareability domain 158. Outer shareability is indicated by a bit in a page table for the page in the cache that is to be accessed.

In the illustrated environment 100, the components in the outer shareability domain 158 are coupled to a coherence bus 160. A Level 3 cache 162 associated with an outer cachability domain 164 and a main memory 166 are also coupled to the coherence bus 160. Outer shareability is indicated by a bit in a page table for the page in the cache that is to be accessed.

Conventionally, with the Level 2 caches 120, 130, 140, and 148 being associated with the outer shareability domain 158 means that the Level 2 caches 120, 130, 140, and 148 may be accessed by the Graphics Processing Unit (GPU) 102, the Digital Signal Processor (DSP) 104, the Central Processing Unit (CPU) 106, the Central Processing Unit (CPU) 108, the Central Processing Unit (CPU) 110, and the Central Processing Unit (CPU) 112. Moreover, on a cache miss in any one of the Level 0 caches 114, 122, 124, 132, 134, or 142, all snoop and invalidate coherence traffic is sent to each of the Level 2 caches 120, 130, 140, and 148. There is no way to limit snoop and invalidate coherence traffic to only the Graphics Processing Unit (GPU) 102, only the Digital Signal Processor (DSP) 104, or only the Central Processing Units (CPUs) 106, 108, 110, or 112.

In one or more implementations of the technology described herein, in addition to using the inner cachability bits, the inner shareability bits, the inner cachability bits, and the outer cachability bits for a particular page, the routing modules 118, 128, 138, and 146 utilize other transaction attributes to route snoop and invalidate coherence traffic to a smaller number of Level 2 caches. The transaction attributes identify the particular role of a processor initiating a coherence transaction within the computing environment 100.

For example, an address space identifier (ASID) may indicate that a coherence transaction was initiated in the Graphics Processing Unit (GPU) 102. Thus, the processor core identified by the address space identifier (ASID) is performing a role of a Graphics Processing Unit (GPU).

Similarly, an address space identifier (ASID) may indicate that a coherence transaction was initiated in the Digital Signal Processor (DSP) 104. Thus, the processor core identified by the address space identifier (ASID) is performing a Digital Signal Processing role.

Likewise, an address space identifier (ASID) may indicate that a coherence transaction was initiated in the Central Processing Unit (CPU) 106, the Central Processing Unit (CPU) 108, the Central Processing Unit (CPU) 110, or the Central Processing Unit (CPU) 112. Thus, the processor core identified by the respective address space identifiers (ASIDs) may be performing a general purpose processing role.

Implementations of the technology described herein may pre-determine that particular processes associated with particular address space identifiers (ASIDs) commonly access particular resources, e.g., processes associated with the Graphics Processing Unit (GPU) 102 commonly access the Central Processing Unit (CPU) 106. One implementation may identify a cachability domain and/or shareability domain for the process associated with that address space identifier (ASID) so that coherence transactions associated with that address space identifier (ASID) are only routed to caches in that cachability domain and/or shareability domain. The coherence transactions associated with that address space identifier (ASID) are not routed outside of that particular cachability domain and/or shareability domain.

For example, if a cachability domain and/or shareability domain identified based on an address space identifier (ASID) includes only the Graphics Processing Unit (GPU) 102 and the Central Processing Unit (CPU) 106, coherence transactions from the Graphics Processing Unit (GPU) 102 will not be routed to the Digital Signal Processor (DSP) 104 because the Digital Signal Processor (DSP) 104 is not in that cachability domain and/or shareability domain.

Reducing the number of caches that are snooped and/or invalidated may reduce coherence bus 160 traffic in the environment 100. Reducing the number of caches that are snooped and/or invalidated also may reduce power consumption in the environment 100 because caches that are not in a particular cachability domain and/or shareability domain do not have to be awakened from a low power mode to service the coherence transaction.

In one or more implementations, a virtual machine identifier (VMID) and the address space identifier (ASID) may indicate that not only was the coherence transaction initiated in the Graphics Processing Unit (GPU) 102, but that the coherence transaction was initiated in by a hypervisor in the Graphics Processing Unit (GPU) 102. A cachability domain and/or shareability domain may be identified for the process associated with that virtual machine identifier (VMID) and that address space identifier (ASID) so that coherence transactions associated with that virtual machine identifier (VMID) and that address space identifier (ASID) are only routed to caches in that cachability domain and/or shareability domain. The coherence transactions associated with that virtual machine identifier (VMID) and that address space identifier (ASID) are not routed outside of that particular cachability domain and/or shareability domain.

In one or more implementations, a hypervisor identifier (HYP) and the address space identifier (ASID) may indicate that not only was the coherence transaction initiated in the Graphics Processing Unit (GPU) 102, but that the coherence transaction was initiated by a hypervisor in the Graphics Processing Unit (GPU) 102. A cachability domain and/or shareability domain may be identified for the process associated with that hypervisor identifier (HYP) and that address space identifier (ASID) so that coherence transactions associated with that hypervisor identifier (HYP) and that address space identifier (ASID) are only routed to caches in that cachability domain and/or shareability domain. The coherence transactions associated with that hypervisor identifier (HYP) and that address space identifier (ASID) are not routed outside of that particular cachability domain and/or shareability domain.

In one or more implementations, a secure root identifier (NS) and the address space identifier (ASID) may indicate that not only was the coherence transaction initiated in the Graphics Processing Unit (GPU) 102, but that the coherence transaction was initiated by a secure root in the Graphics Processing Unit (GPU) 102. A cachability domain and/or shareability domain may be identified for the process associated with that secure root identifier (NS) and that address space identifier (ASID) so that coherence transactions associated with that secure root identifier (NS) and that address space identifier (ASID) are only routed to caches in that cachability domain and/or shareability domain. The coherence transactions associated with that secure root identifier (NS) and that address space identifier (ASID) are not routed outside of that particular cachability domain and/or shareability domain. In one or more implementations, transaction attributes by be identified using configuration bits in the associated memory management unit (MMU).

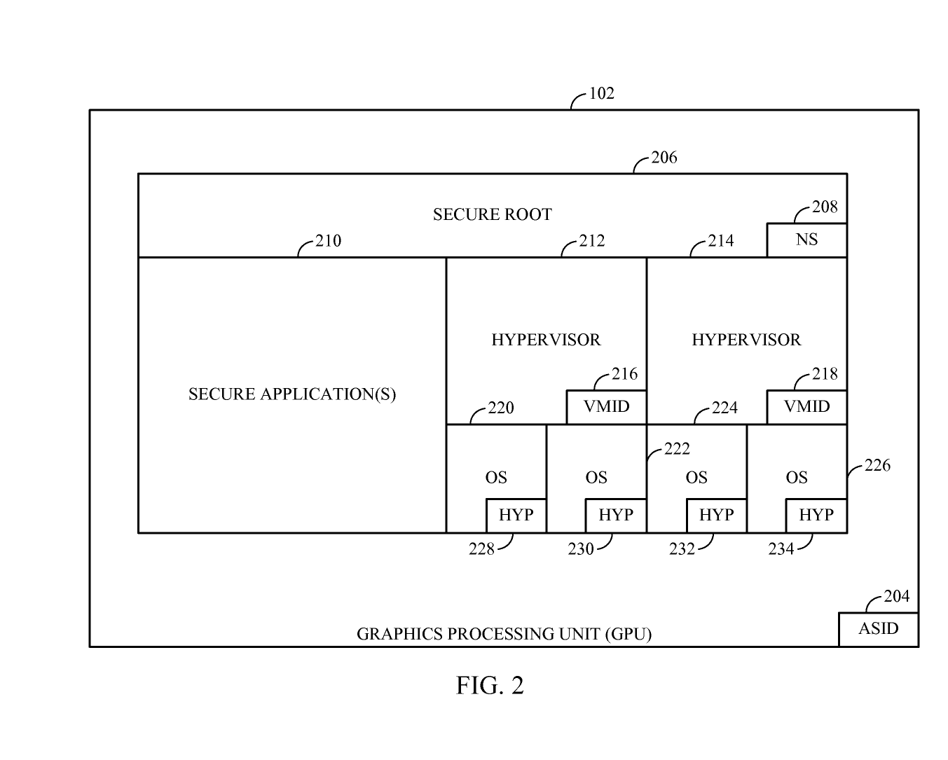

FIG. 2 illustrates the Graphics Processing Unit (GPU) 102 in more detail according to one or more implementations of the technology described herein. The Graphics Processing Unit (GPU) 102 illustrated in FIG. 2 may be used to identify a cachability domain and/or shareability domain as described above with reference to FIG. 1. The illustrated Graphics Processing Unit (GPU) 102 is associated with an address space identifier (ASID) 204. The Graphics Processing Unit (GPU) 102 executes a secure root 206, which is associated with a secure root identifier (NS) 208.

The Graphics Processing Unit (GPU) 102 also executes secure applications 210 a hypervisor 212, and a hypervisor 214. The hypervisor 212 is associated with a virtual machine identifier (VMID) 216. The hypervisor 214 is associated with a virtual machine identifier (VMID) 218.

The illustrated Graphics Processing Unit (GPU) 102 also executes an operating system (OS) 220, an operating system (OS) 222, an operating system (OS) 224, and an operating system (OS) 226. The operating system (OS) 220 is associated with a hypervisor identifier (HYP) 228. The operating system (OS) 222 is associated with a hypervisor identifier (HYP) 230. The operating system (OS) 224 is associated with a hypervisor identifier (HYP) 232. The operating system (OS) 226 is associated with a hypervisor identifier (HYP) 234.

A coherence transaction that includes the address space identifier (ASID) 204 indicates that the coherence transaction was initiated by the Graphics Processing Unit (GPU) 102. A coherence transaction that includes the virtual machine identifier (VMID) 216 and the address space identifier (ASID) 204 may indicate that not only was the coherence transaction initiated in the Graphics Processing Unit (GPU) 102, but that the coherence transaction was initiated in by the hypervisor 212. A coherence transaction that includes the virtual machine identifier (VMID) 218 and the address space identifier (ASID) 204 may indicate that not only was the coherence transaction initiated in the Graphics Processing Unit (GPU) 102, but that the coherence transaction was initiated in by the hypervisor 214.

A coherence transaction that includes the hypervisor identifier (HYP) 228 and the address space identifier (ASID) 204 may indicate that not only was the coherence transaction initiated in the Graphics Processing Unit (GPU) 102, but that the coherence transaction was initiated in by the operating system (OS) 220. A coherence transaction that includes the hypervisor identifier (HYP) 230 and the address space identifier (ASID) 204 may indicate that not only was the coherence transaction initiated in the Graphics Processing Unit (GPU) 102, but that the coherence transaction was initiated in by the operating system (OS) 222.

A coherence transaction that includes the hypervisor identifier (HYP) 232 and the address space identifier (ASID) 204 may indicate that not only was the coherence transaction initiated in the Graphics Processing Unit (GPU) 102, but that the coherence transaction was initiated in by the operating system (OS) 224. A coherence transaction that includes the hypervisor identifier (HYP) 234 and the address space identifier (ASID) 204 may indicate that not only was the coherence transaction initiated in the Graphics Processing Unit (GPU) 102, but that the coherence transaction was initiated in by the operating system (OS) 226.

One implementation may identify a cachability domain and/or shareability domain for the process associated with that address space identifier (ASID) 204 so that coherence transactions associated with that address space identifier (ASID) 204 are only routed to caches in that cachability domain and/or shareability domain. The coherence transactions associated with that address space identifier (ASID) 204 are not routed outside of that particular cachability domain and/or shareability domain. Once the transaction attributes have been identified, the cachability domain and/or shareability domain may be identified in accordance with known practices using the coherence bus 160.

For example, if a cachability domain and/or shareability domain identified based on the address space identifier (ASID) 204 includes only the Graphics Processing Unit (GPU) 102 and the Central Processing Unit (CPU) 106, coherence transactions from the Graphics Processing Unit (GPU) 102 and the Central Processing Unit (CPU) 106 associated with the address space identifier (ASID) 204 will not be routed to the Digital Signal Processor (DSP) 104 because the Digital Signal Processor (DSP) 104 is not in the cachability domain and/or shareability domain associated with the address space identifier (ASID) 204.

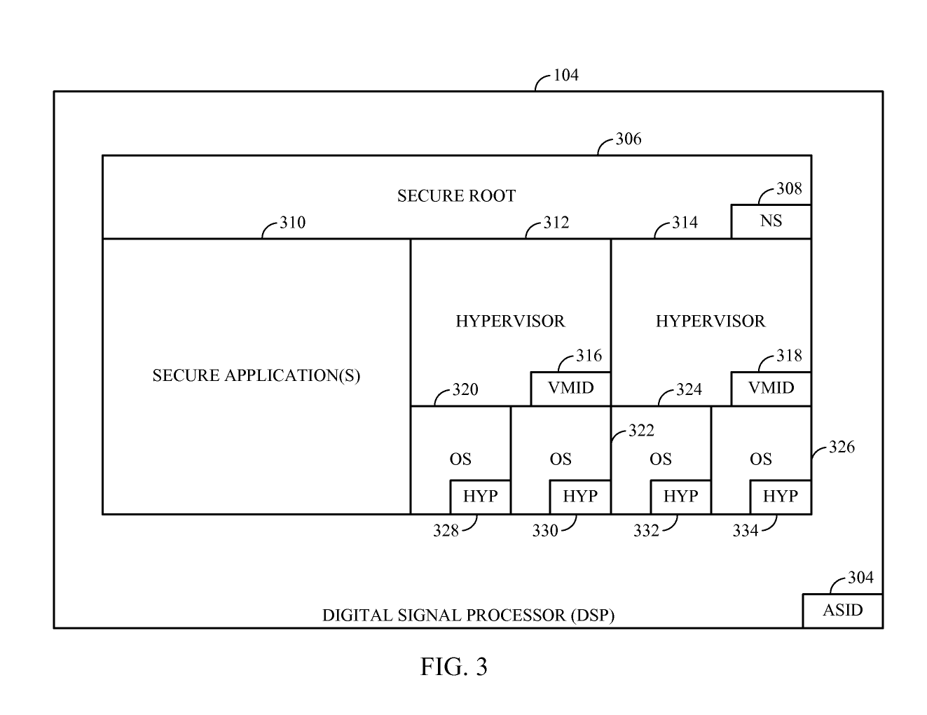

FIG. 3 illustrates the Digital Signal Processor (DSP) 104 in more detail according to one or more implementations of the technology described herein. The Digital Signal Processor (DSP) 104 illustrated in FIG. 3 may be used to identify a cachability domain and/or shareability domain as described above with reference to FIG. 1. The illustrated Digital Signal Processor (DSP) 104 is associated with an address space identifier (ASID) 304. The Digital Signal Processor (DSP) 104 executes a secure root 306, which is associated with a secure root identifier (NS) 308.

The Digital Signal Processor (DSP) 104 also executes secure applications 310 and a hypervisor 312, a hypervisor 314. The hypervisor 312 is associated with a virtual machine identifier (VMID) 316. The hypervisor 314 is associated with a virtual machine identifier (VMID) 318.

The illustrated Digital Signal Processor (DSP) 104 also executes an operating system (OS) 320, an operating system (OS) 322, an operating system (OS) 324, and an operating system (OS) 326. The operating system (OS) 320 is associated with a hypervisor identifier (HYP) 328. The operating system (OS) 322 is associated with a hypervisor identifier (HYP) 330. The operating system (OS) 324 is associated with a hypervisor identifier (HYP) 332. The operating system (OS) 326 is associated with a hypervisor identifier (HYP) 334.

A coherence transaction that includes the address space identifier (ASID) 304 indicates that the coherence transaction was initiated by the Digital Signal Processor (DSP) 104. A coherence transaction that includes the virtual machine identifier (VMID) 316 and the address space identifier (ASID) 304 may indicate that not only was the coherence transaction initiated in the Digital Signal Processor (DSP) 104, but that the coherence transaction was initiated in by the hypervisor 312. A coherence transaction that includes the virtual machine identifier (VMID) 318 and the address space identifier (ASID) 304 may indicate that not only was the coherence transaction initiated in the Digital Signal Processor (DSP) 104, but that the coherence transaction was initiated in by the hypervisor 314.

A coherence transaction that includes the hypervisor identifier (HYP) 328 and the address space identifier (ASID) 304 may indicate that not only was the coherence transaction initiated in the Digital Signal Processor (DSP) 104, but that the coherence transaction was initiated in by the operating system (OS) 320. A coherence transaction that includes the hypervisor identifier (HYP) 330 and the address space identifier (ASID) 304 may indicate that not only was the coherence transaction initiated in the Digital Signal Processor (DSP) 104, but that the coherence transaction was initiated in by the operating system (OS) 322.

A coherence transaction that includes the hypervisor identifier (HYP) 332 and the address space identifier (ASID) 304 may indicate that not only was the coherence transaction initiated in the Digital Signal Processor (DSP) 104, but that the coherence transaction was initiated in by the operating system (OS) 324. A coherence transaction that includes the hypervisor identifier (HYP) 334 and the address space identifier (ASID) 304 may indicate that not only was the coherence transaction initiated in the Digital Signal Processor (DSP) 104, but that the coherence transaction was initiated in by the operating system (OS) 326.

One implementation may identify a cachability domain and/or shareability domain for the process associated with that address space identifier (ASID) 304 so that coherence transactions associated with this transaction attribute are only routed to caches in the associated cachability domain and/or shareability domain.

For example, if a cachability domain and/or shareability domain identified based on the address space identifier (ASID) 304 includes only the Digital Signal Processor (DSP) 104 and the Central Processing Unit (CPU) 106, coherence transactions from the Digital Signal Processor (DSP) 104 associated with the address space identifier (ASID) 304 will not be routed to the Central Processing Unit (CPU) 108 because the Central Processing Unit (CPU) 108 is not in the cachability domain and/or shareability domain associated with the address space identifier (ASID) 304.

Of course, the cachability domain and/or shareability domain associated with the address space identifier (ASID) 304 can be further limited using any combination of the secure root identifier (NS) 308, the virtual machine identifier (VMID) 316, the virtual machine identifier (VMID) 318, the hypervisor identifier (HYP) 328, the hypervisor identifier (HYP) 330, the hypervisor identifier (HYP) 332, or the hypervisor identifier (HYP) 334. The coupling of these other transaction attributes with the associated with the space identifier (ASID) 304 may further narrow the selection of caches to be snooped or invalidated.

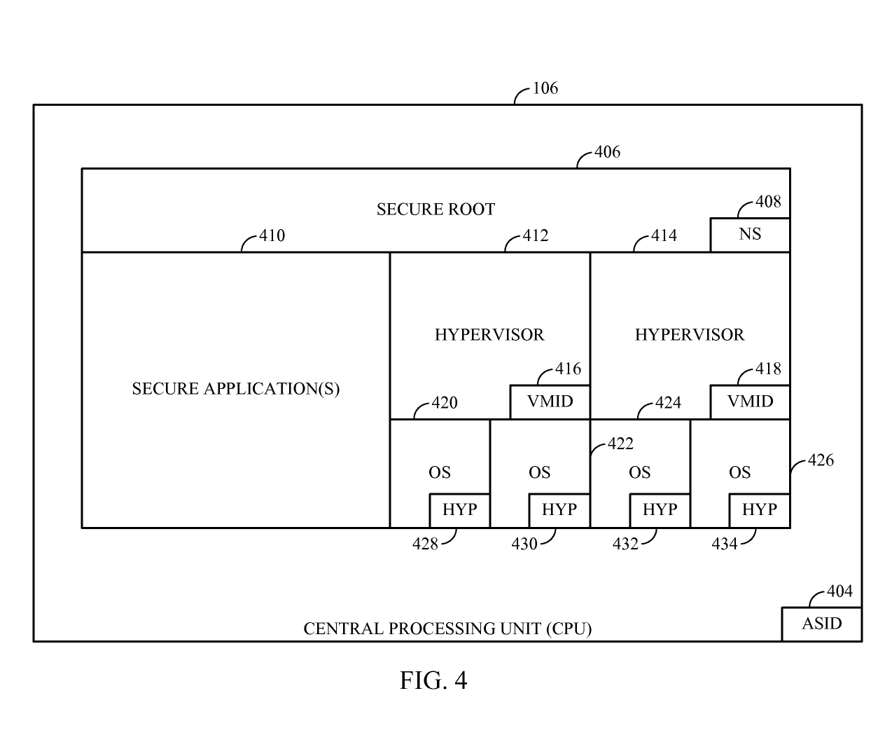

FIG. 4 illustrates the Central Processing Unit (CPU) 106 in more detail according to one or more implementations of the technology described herein. The Central Processing Unit (CPU) 106 illustrated in FIG. 4 may be used to identify a cachability domain and/or shareability domain as described above with reference to FIG. 1. The illustrated Central Processing Unit (CPU) 106 is associated with an address space identifier (ASID) 404. Central Processing Unit (CPU) 106 executes a secure root 406, which is associated with a secure root identifier (NS) 408.

The Central Processing Unit (CPU) 106 also executes secure applications 410 and a hypervisor 412, a hypervisor 414. The hypervisor 412 is associated with a virtual machine identifier (VMID) 416. The hypervisor 414 is associated with a virtual machine identifier (VMID) 418.

The illustrated Central Processing Unit (CPU) 106 also executes an operating system (OS) 420, an operating system (OS) 422, an operating system (OS) 424, and an operating system (OS) 426. The operating system (OS) 420 is associated with a hypervisor identifier (HYP) 428. The operating system (OS) 422 is associated with a hypervisor identifier (HYP) 430. The operating system (OS) 424 is associated with a hypervisor identifier (HYP) 432. The operating system (OS) 426 is associated with a hypervisor identifier (HYP) 434.

A coherence transaction that includes the address space identifier (ASID) 404 indicates that the coherence transaction was initiated by the Central Processing Unit (CPU) 106. A coherence transaction that includes the virtual machine identifier (VMID) 416 and the address space identifier (ASID) 404 may indicate that not only was the coherence transaction initiated in the Central Processing Unit (CPU) 106, but that the coherence transaction was initiated in by the hypervisor 412. A coherence transaction that includes the virtual machine identifier (VMID) 418 and the address space identifier (ASID) 404 may indicate that not only was the coherence transaction initiated in the Central Processing Unit (CPU) 106, but that the coherence transaction was initiated in by the hypervisor 414.

A coherence transaction that includes the hypervisor identifier (HYP) 428 and the address space identifier (ASID) 404 may indicate that not only was the coherence transaction initiated in the Central Processing Unit (CPU) 106, but that the coherence transaction was initiated in by the operating system (OS) 420. A coherence transaction that includes the hypervisor identifier (HYP) 430 and the address space identifier (ASID) 404 may indicate that not only was the coherence transaction initiated in the Central Processing Unit (CPU) 106, but that the coherence transaction was initiated in by the operating system (OS) 422.

A coherence transaction that includes the hypervisor identifier (HYP) 432 and the address space identifier (ASID) 404 may indicate that not only was the coherence transaction initiated in the Central Processing Unit (CPU) 106, but that the coherence transaction was initiated in by the operating system (OS) 424. A coherence transaction that includes the hypervisor identifier (HYP) 434 and the address space identifier (ASID) 404 may indicate that not only was the coherence transaction initiated in the Central Processing Unit (CPU) 106, but that the coherence transaction was initiated in by the operating system (OS) 426.

One implementation may identify a cachability domain and/or shareability domain for the process associated with that address space identifier (ASID) 404 so that coherence transactions associated with that address space identifier (ASID) 404 are only routed to caches in that cachability domain and/or shareability domain. The coherence transactions associated with that address space identifier (ASID) 404 are not routed outside of that particular cachability domain and/or shareability domain.

For example, if a cachability domain and/or shareability domain identified based on the address space identifier (ASID) 404 includes only the Digital Signal Processor (DSP) 104 and the Central Processing Unit (CPU) 106, coherence transactions from the Digital Signal Processor (DSP) 104 or the Central Processing Unit (CPU) 106 associated with the address space identifier (ASID) 404 will not be routed to the Central Processing Unit (CPU) 108 because the Central Processing Unit (CPU) 108 is not in that cachability domain and/or shareability domain associated with the address space identifier (ASID) 404.

Similarly, if a cachability domain and/or shareability domain identified based on the address space identifier (ASID) 404 includes only the Digital Signal Processor (DSP) 104, the Central Processing Unit (CPU) 106, and the Central Processing Unit (CPU) 112 coherence transactions from the Digital Signal Processor (DSP) 104, the Central Processing Unit (CPU) 106, and the Central Processing Unit (CPU) 112 associated with the address space identifier (ASID) 404 will not be routed to the Central Processing Unit (CPU) 108 because the Central Processing Unit (CPU) 108 is not in the cachability domain and/or shareability domain associated with the address space identifier (ASID) 404.

Of course, the cachability domain and/or shareability domain associated with the address space identifier (ASID) 404 can be further limited using any combination of the secure root identifier (NS) 408, the virtual machine identifier (VMID) 416, the virtual machine identifier (VMID) 418, the hypervisor identifier (HYP) 428, the hypervisor identifier (HYP) 430, the hypervisor identifier (HYP) 432, or the hypervisor identifier (HYP) 434. The coupling of these other transaction attributes with the associated with the space identifier (ASID) 404 may further narrow the selection of caches to be snooped or invalidated.

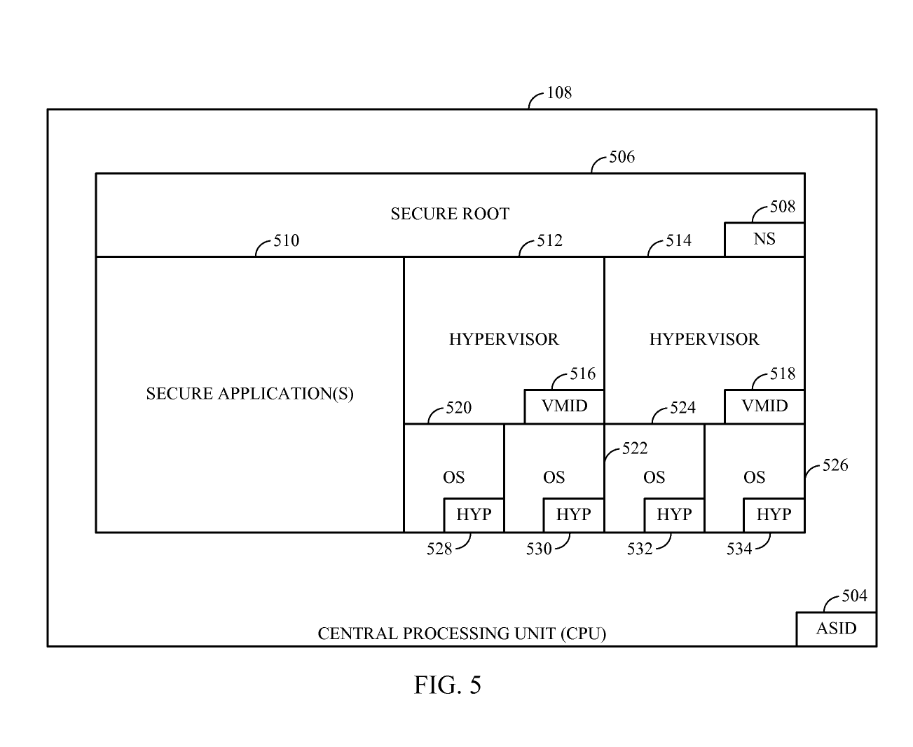

FIG. 5 illustrates the Central Processing Unit (CPU) 108 in more detail according to one or more implementations of the technology described herein. The Central Processing Unit (CPU) 108 illustrated in FIG. 5 may be used to identify a cachability domain and/or shareability domain as described above with reference to FIG. 1. The illustrated Central Processing Unit (CPU) 108 is associated with an address space identifier (ASID) 504. The Central Processing Unit (CPU) 108 executes a secure root 506, which is associated with a secure root identifier (NS) 508.

The Central Processing Unit (CPU) 108 also executes secure applications 510 and a hypervisor 512, a hypervisor 514. The hypervisor 512 is associated with a virtual machine identifier (VMID) 516. The hypervisor 514 is associated with a virtual machine identifier (VMID) 518.

The illustrated Central Processing Unit (CPU) 108 also executes an operating system (OS) 520, an operating system (OS) 522, an operating system (OS) 524, and an operating system (OS) 526. The operating system (OS) 520 is associated with a hypervisor identifier (HYP) 528. The operating system (OS) 522 is associated with a hypervisor identifier (HYP) 530. The operating system (OS) 524 is associated with a hypervisor identifier (HYP) 532. The operating system (OS) 526 is associated with a hypervisor identifier (HYP) 534.

A coherence transaction that includes the address space identifier (ASID) 504 indicates that the coherence transaction was initiated by the Central Processing Unit (CPU) 108. A coherence transaction that includes the virtual machine identifier (VMID) 516 and the address space identifier (ASID) 504 may indicate that not only was the coherence transaction initiated in the Digital Signal Processor (DSP) 104, but that the coherence transaction was initiated in by the hypervisor 512. A coherence transaction that includes the virtual machine identifier (VMID) 518 and the address space identifier (ASID) 504 may indicate that not only was the coherence transaction initiated in the Digital Signal Processor (DSP) 104, but that the coherence transaction was initiated in by the hypervisor 514.

A coherence transaction that includes the hypervisor identifier (HYP) 528 and the address space identifier (ASID) 504 may indicate that not only was the coherence transaction initiated in the Central Processing Unit (CPU) 108, but that the coherence transaction was initiated in by the operating system (OS) 520. A coherence transaction that includes the hypervisor identifier (HYP) 530 and the address space identifier (ASID) 504 may indicate that not only was the coherence transaction initiated in the Central Processing Unit (CPU) 108, but that the coherence transaction was initiated in by the operating system (OS) 522.

A coherence transaction that includes the hypervisor identifier (HYP) 532 and the address space identifier (ASID) 504 may indicate that not only was the coherence transaction initiated in the Central Processing Unit (CPU) 108, but that the coherence transaction was initiated in by the operating system (OS) 524. A coherence transaction that includes the hypervisor identifier (HYP) 534 and the address space identifier (ASID) 504 may indicate that not only was the coherence transaction initiated in the Central Processing Unit (CPU) 108, but that the coherence transaction was initiated in by the operating system (OS) 526.

One implementation may identify a cachability domain and/or shareability domain for the process associated with that address space identifier (ASID) 504 so that coherence transactions associated with that address space identifier (ASID) 504 are only routed to caches in that cachability domain and/or shareability domain. The coherence transactions associated with that address space identifier (ASID) 504 are not routed outside of that particular cachability domain and/or shareability domain.

For example, if a cachability domain and/or shareability domain identified based on the address space identifier (ASID) 504 includes only the Digital Signal Processor (DSP) 104 and the Central Processing Unit (CPU) 108, coherence transactions from the Digital Signal Processor (DSP) 104 and the Central Processing Unit (CPU) 108 will not be routed to the Central Processing Unit (CPU) 112 because the Central Processing Unit (CPU) 112 is not in that cachability domain and/or shareability domain associated with that address space identifier (ASID) 504.

Similarly, if a cachability domain and/or shareability domain identified based on the address space identifier (ASID) 504 includes only the Digital Signal Processor (DSP) 104, the Central Processing Unit (CPU) 108, and the Central Processing Unit (CPU) 112 coherence transactions from the Digital Signal Processor (DSP) 104, the Central Processing Unit (CPU) 108, and the Central Processing Unit (CPU) 112 will not be routed to the Central Processing Unit (CPU) 110 because the Central Processing Unit (CPU) 110 is not in the cachability domain and/or shareability domain associated with the address space identifier (ASID) 504.

Of course, the cachability domain and/or shareability domain associated with the address space identifier (ASID) 504 can be further limited using any combination of the secure root identifier (NS) 508, the virtual machine identifier (VMID) 516, the virtual machine identifier (VMID) 518, the hypervisor identifier (HYP) 528, the hypervisor identifier (HYP) 530, the hypervisor identifier (HYP) 532, or the hypervisor identifier (HYP) 534. The coupling of these other transaction attributes with the associated with the space identifier (ASID) 504 may further narrow the selection of caches to be snooped or invalidated.

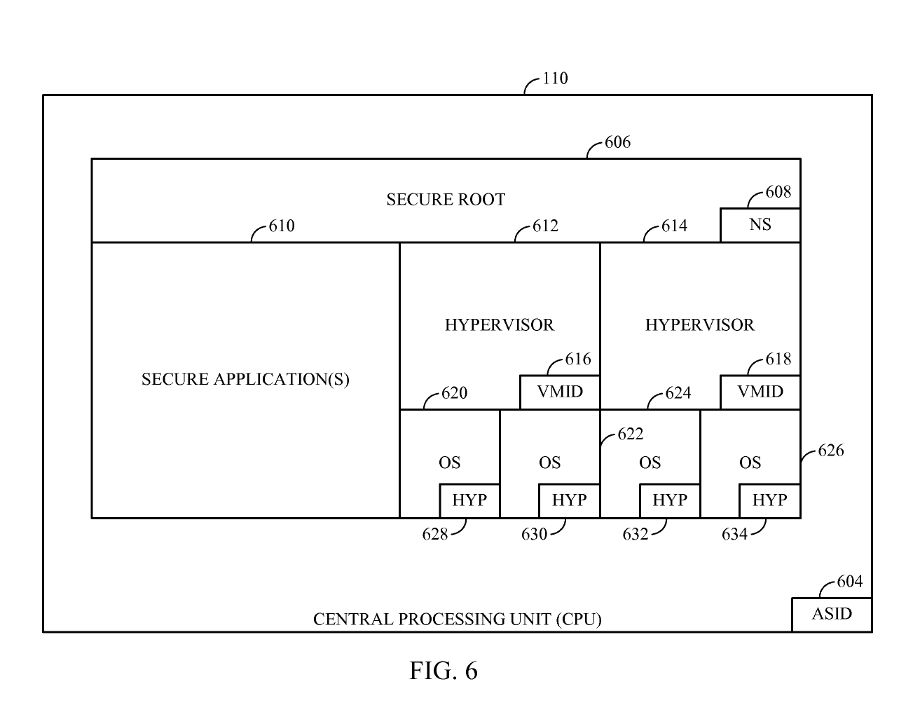

FIG. 6 illustrates the Central Processing Unit (CPU) 110 in more detail according to one or more implementations of the technology described herein. The Central Processing Unit (CPU) 110 illustrated in FIG. 6 may be used to identify a cachability domain and/or shareability domain as described above with reference to FIG. 1. The illustrated Central Processing Unit (CPU) 110 is associated with an address space identifier (ASID) 604. The Central Processing Unit (CPU) 110 executes a secure root 606, which is associated with a secure root identifier (NS) 608.

The Central Processing Unit (CPU) 110 also executes secure applications 610 and a hypervisor 612, a hypervisor 614. The hypervisor 612 is associated with a virtual machine identifier (VMID) 616. The hypervisor 614 is associated with a virtual machine identifier (VMID) 618.

The illustrated Central Processing Unit (CPU) 110 also executes an operating system (OS) 620, an operating system (OS) 622, an operating system (OS) 624, and an operating system (OS) 626. The operating system (OS) 620 is associated with a hypervisor identifier (HYP) 628. The operating system (OS) 622 is associated with a hypervisor identifier (HYP) 630. The operating system (OS) 624 is associated with a hypervisor identifier (HYP) 632. The operating system (OS) 626 is associated with a hypervisor identifier (HYP) 634.

A coherence transaction that includes the address space identifier (ASID) 604 indicates that the coherence transaction was initiated by the Central Processing Unit (CPU) 110. A coherence transaction that includes the virtual machine identifier (VMID) 616 and the address space identifier (ASID) 604 may indicate that not only was the coherence transaction initiated in the Digital Signal Processor (DSP) 104, but that the coherence transaction was initiated in by the hypervisor 612. A coherence transaction that includes the virtual machine identifier (VMID) 618 and the address space identifier (ASID) 604 may indicate that not only was the coherence transaction initiated in the Digital Signal Processor (DSP) 104, but that the coherence transaction was initiated in by the hypervisor 614.

A coherence transaction that includes the hypervisor identifier (HYP) 628 and the address space identifier (ASID) 604 may indicate that not only was the coherence transaction initiated in the Central Processing Unit (CPU) 110, but that the coherence transaction was initiated in by the operating system (OS) 620. A coherence transaction that includes the hypervisor identifier (HYP) 630 and the address space identifier (ASID) 604 may indicate that not only was the coherence transaction initiated in the Central Processing Unit (CPU) 110, but that the coherence transaction was initiated in by the operating system (OS) 622.

A coherence transaction that includes the hypervisor identifier (HYP) 632 and the address space identifier (ASID) 604 may indicate that not only was the coherence transaction initiated in the Central Processing Unit (CPU) 110, but that the coherence transaction was initiated in by the operating system (OS) 624. A coherence transaction that includes the hypervisor identifier (HYP) 634 and the address space identifier (ASID) 604 may indicate that not only was the coherence transaction initiated in the Central Processing Unit (CPU) 110, but that the coherence transaction was initiated in by the operating system (OS) 626.

One implementation may identify a cachability domain and/or shareability domain for the process associated with that address space identifier (ASID) 604 so that coherence transactions associated with that address space identifier (ASID) 404 are only routed to caches in that cachability domain and/or shareability domain. The coherence transactions associated with that address space identifier (ASID) 604 are not routed outside of that particular cachability domain and/or shareability domain.

For example, if a cachability domain and/or shareability domain identified based on the address space identifier (ASID) 604 includes only the Digital Signal Processor (DSP) 104 and the Central Processing Unit (CPU) 110, coherence transactions from the Digital Signal Processor (DSP) 104 or the Central Processing Unit (CPU) 110 will not be routed to the Central Processing Unit (CPU) 112 because the Central Processing Unit (CPU) 112 is not in the cachability domain and/or shareability domain associated with the address space identifier (ASID) 604.

Similarly, if a cachability domain and/or shareability domain identified based on the address space identifier (ASID) 604 includes only the Digital Signal Processor (DSP) 104, the Central Processing Unit (CPU) 110, and the Central Processing Unit (CPU) 112 coherence transactions from the Digital Signal Processor (DSP) 104, the Central Processing Unit (CPU) 110, and the Central Processing Unit (CPU) 112 will not be routed to the Central Processing Unit (CPU) 106 because the Central Processing Unit (CPU) 106 is not in the cachability domain and/or shareability domain associated with the address space identifier (ASID) 604.

Of course, the cachability domain and/or shareability domain associated with the address space identifier (ASID) 604 can be further limited using any combination of the secure root identifier (NS) 608, the virtual machine identifier (VMID) 616, the virtual machine identifier (VMID) 618, the hypervisor identifier (HYP) 628, the hypervisor identifier (HYP) 630, the hypervisor identifier (HYP) 632, or the hypervisor identifier (HYP) 634. The coupling of these other transaction attributes with the associated with the space identifier (ASID) 604 may further narrow the selection of caches to be snooped or invalidated.

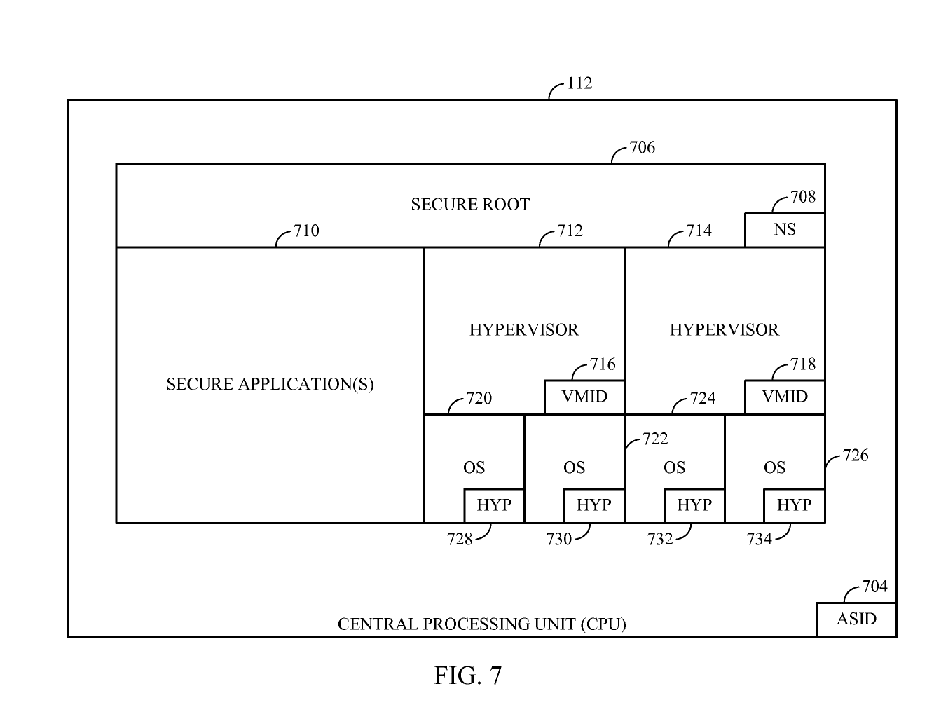

FIG. 7 illustrates the Central Processing Unit (CPU) 112 in more detail according to one or more implementations of the technology described herein. The Central Processing Unit (CPU) 112 illustrated in FIG. 7 may be used to identify a cachability domain and/or shareability domain as described above with reference to FIG. 1. The illustrated Central Processing Unit (CPU) 112 is associated with an address space identifier (ASID) 704. The Central Processing Unit (CPU) 112 executes a secure root 706, which is associated with a secure root identifier (NS) 708.

The Central Processing Unit (CPU) 112 also executes secure applications 710 and a hypervisor 712, a hypervisor 714. The hypervisor 712 is associated with a virtual machine identifier (VMID) 716. The hypervisor 714 is associated with a virtual machine identifier (VMID) 718.

The illustrated Central Processing Unit (CPU) 112 also executes an operating system (OS) 720, an operating system (OS) 722, an operating system (OS) 724, and an operating system (OS) 726. The operating system (OS) 720 is associated with a hypervisor identifier (HYP) 728. The operating system (OS) 722 is associated with a hypervisor identifier (HYP) 730. The operating system (OS) 724 is associated with a hypervisor identifier (HYP) 732. The operating system (OS) 726 is associated with a hypervisor identifier (HYP) 734.

A coherence transaction that includes the address space identifier (ASID) 704 indicates that the coherence transaction was initiated by the Central Processing Unit (CPU) 112. A coherence transaction that includes the virtual machine identifier (VMID) 716 and the address space identifier (ASID) 704 may indicate that not only was the coherence transaction initiated in the Digital Signal Processor (DSP) 104, but that the coherence transaction was initiated in by the hypervisor 712. A coherence transaction that includes the virtual machine identifier (VMID) 718 and the address space identifier (ASID) 704 may indicate that not only was the coherence transaction initiated in the Digital Signal Processor (DSP) 104, but that the coherence transaction was initiated in by the hypervisor 714.

A coherence transaction that includes the hypervisor identifier (HYP) 728 and the address space identifier (ASID) 704 may indicate that not only was the coherence transaction initiated in the Central Processing Unit (CPU) 112, but that the coherence transaction was initiated in by the operating system (OS) 720. A coherence transaction that includes the hypervisor identifier (HYP) 730 and the address space identifier (ASID) 704 may indicate that not only was the coherence transaction initiated in the Central Processing Unit (CPU) 112, but that the coherence transaction was initiated in by the operating system (OS) 722.

A coherence transaction that includes the hypervisor identifier (HYP) 732 and the address space identifier (ASID) 704 may indicate that not only was the coherence transaction initiated in the Central Processing Unit (CPU) 112, but that the coherence transaction was initiated in by the operating system (OS) 724. A coherence transaction that includes the hypervisor identifier (HYP) 734 and the address space identifier (ASID) 704 may indicate that not only was the coherence transaction initiated in the Central Processing Unit (CPU) 112, but that the coherence transaction was initiated in by the operating system (OS) 726.

One implementation may identify a cachability domain and/or shareability domain for the process associated with that address space identifier (ASID) 704 so that coherence transactions associated with that address space identifier (ASID) 704 are only routed to caches in that cachability domain and/or shareability domain. The coherence transactions associated with that address space identifier (ASID) 704 are not routed outside of that particular cachability domain and/or shareability domain.

For example, if a cachability domain and/or shareability domain identified based on the address space identifier (ASID) 704 includes only the Digital Signal Processor (DSP) 104 and the Central Processing Unit (CPU) 112, coherence transactions from the Digital Signal Processor (DSP) 104 or the Central Processing Unit (CPU) 112 will not be routed to the Graphics Processing Unit (GPU) 102 because the Graphics Processing Unit (GPU) 102 is not in the cachability domain and/or shareability domain associated with the address space identifier (ASID) 704.

Similarly, if a cachability domain and/or shareability domain identified based on the address space identifier (ASID) 704 includes only the Digital Signal Processor (DSP) 104, the Central Processing Unit (CPU) 112, and the Central Processing Unit (CPU) 112 coherence transactions from the Digital Signal Processor (DSP) 104, the Central Processing Unit (CPU) 112, and the Central Processing Unit (CPU) 112 will not be routed to the Central Processing Unit (CPU) 112 because the Central Processing Unit (CPU) 112 is not in the cachability domain and/or shareability domain associated with the address space identifier (ASID) 704.

Of course, the cachability domain and/or shareability domain associated with the address space identifier (ASID) 704 can be further limited using any combination of the secure root identifier (NS) 708, the virtual machine identifier (VMID) 716, the virtual machine identifier (VMID) 718, the hypervisor identifier (HYP) 728, the hypervisor identifier (HYP) 730, the hypervisor identifier (HYP) 732, or the hypervisor identifier (HYP) 734. The coupling of these other transaction attributes with the associated with the space identifier (ASID) 704 may further narrow the selection of caches to be snooped or invalidated.

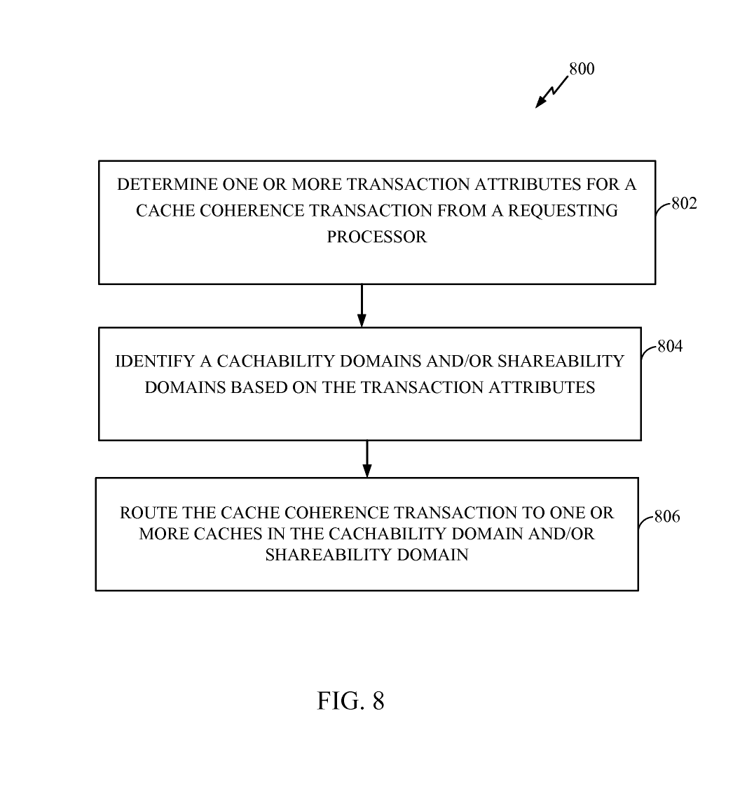

FIG. 8 is an example flow diagram illustrating a method 800 for routing a coherence request to one or more caches in a computing system.

In a block 802, the method 800 determines one or more transaction attributes for a cache coherence transaction from a requesting processor. In one or more implementations, the method 800 determines one or more transaction attributes for a cache coherence transaction from the Graphics Processing Unit (GPU) 102, the Digital Signal Processor (DSP) 104, the Central Processing Unit (CPU) 106, the Central Processing Unit (CPU) 108, the Central Processing Unit (CPU) 110, or the Central Processing Unit (CPU) 112.

In a block 804, the method 800 identifies a cachability domain and/or shareability domain based on the transaction attributes. In one or more implementations, the associated routing module identifies a cachability domain and/or shareability domain based on the address space identifier (ASID), secure root identifier (NS), virtual machine identifier (VMID), or hypervisor identifier (HYP) for the requesting processor.

In a block 808, the method 800 routes the cache coherence transaction to one or more caches in the identified cachability domain and/or shareability domain. In one or more implementations, the associated routing modules route the coherence request to the selected Level 2 cache(s).

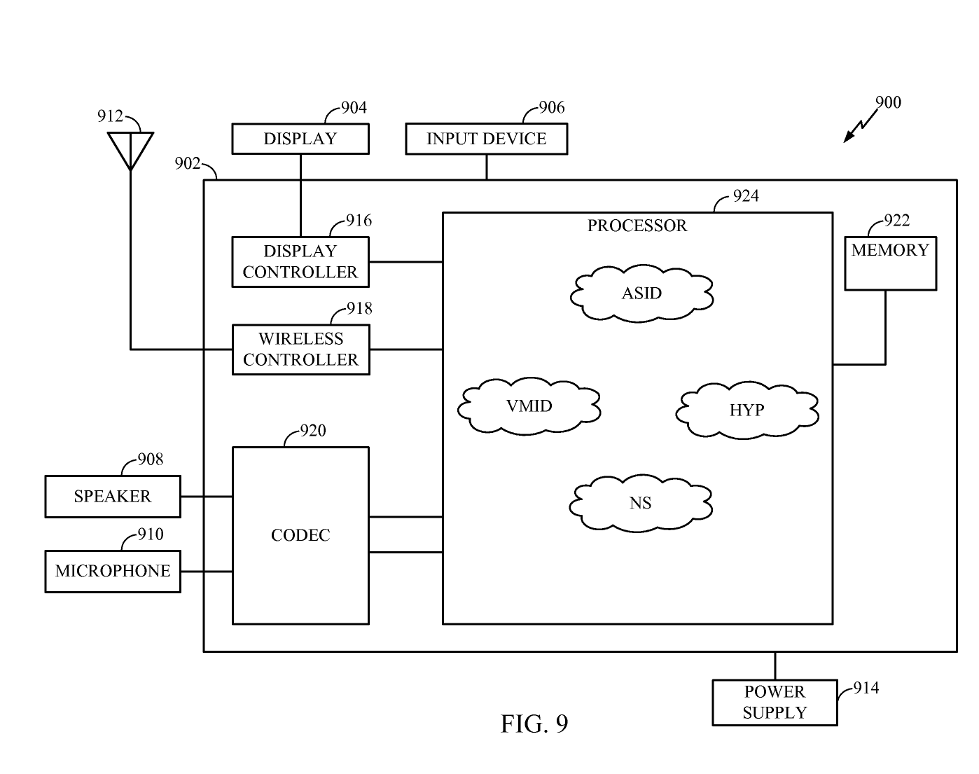

FIG. 9 illustrates a wireless device 900 configured according to one or more implementations of the technology described herein. The illustrated system 900 is suitable for implementing role based cache coherence bus traffic reduction and may be integrated into a set-top box, a music player, a video player, an entertainment unit, a navigation device, a communications device, a personal digital assistant (PDA), a mobile phone, a smart phone, a laptop, a fixed location data unit, or a computer.

The illustrated wireless device 900 includes a system-in-package or system-on-chip device 902 (i.e., an integrated circuit), a display 904, an input device 906, a speaker 908, a microphone 910, an antenna 912, and a power supply 914. The illustrated system-in-package or system-on-chip device 902 includes a display controller 916, a wireless controller 918, a CODEC 920, a memory 922, which may be the memory 166, and a processor 102, which may be the Graphics Processing Unit (GPU) 102, the Digital Signal Processor (DSP) 104, the Central Processing Unit (CPU) 106, the Central Processing Unit (CPU) 108, the Central Processing Unit (CPU) 110, and/or the Central Processing Unit (CPU) 112.

The illustrated display 904 is coupled to the display controller 916, which is coupled to the processor 924. The illustrated speaker 908 and microphone 910 are coupled to the Coder/Decoder (CODEC) 920, which is coupled to the processor 924. The illustrated antenna 912 is coupled to the wireless controller 918, which is coupled to the processor 924.

The illustrated processor 924 can correspond to any of the processes depicted in FIGS. 2 through 7, and may be associated with address space identifiers (ASID), secure root identifiers (NS), virtual machine identifiers (VMID), and hypervisor identifiers (HYP) as described with reference to those FIGs.

The wireless controller 1018 may include a modem. The CODEC 1020 may be an audio and/or voice CODEC.

Aspects of the technology disclosed in the above description and related drawings are directed to specific implementations. Alternative implementations may be devised without departing from the scope of the technology disclosed herein. Additionally, well-known elements of the technology disclosed herein are not described in detail or are omitted so as not to obscure the relevant details of the technology disclosed herein.

The word exemplary is used herein to mean serving as an example, instance, or illustration. Any implementation described herein as exemplary is not necessarily to be construed as preferred or advantageous over other implementations. Likewise, the term implementations does not require that all implementations of the technology described herein include the discussed feature, advantage, or mode of operation.

The terminology used herein is for the purpose of describing particular implementations only and is not intended to be limiting of implementations of the technology described herein. As used herein, the singular forms a, an, and the are intended to include the plural forms as well, unless the context clearly indicates otherwise. It will be further understood that the terms comprises, comprising, includes, and/or including, when used herein, specify the presence of stated features, integers, steps, operations, elements, and/or components, but do not preclude the presence or addition of one or more other features, integers, steps, operations, elements, components, and/or groups thereof.

Further, many implementations are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be implemented entirely within any form of computer readable storage medium having stored therein a corresponding set of computer instructions that upon execution would cause an associated processor to perform the functionality described herein. Thus, the various aspects of the technology disclosed herein may be implemented in a number of different forms, all of which have been contemplated to be within the scope of the claimed subject matter. In addition, for each of the implementations described herein, the corresponding form of any such implementations may be described herein as, for example, logic configured to perform the described action.

Those of skill in the art will appreciate that information and signals may be represented using any of a variety of different technologies and techniques. For example, information and signals may be represented using data, instructions, commands, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the technology disclosed herein.

The methods, sequences, and/or algorithms described in connection with the implementations disclosed herein may be implemented directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor.

Accordingly, implementations of the technology disclosed herein can include a computer readable media embodying a method implementing role based cache coherence bus traffic control. Accordingly, implementations are not limited to illustrated examples and any means for performing the functionality described herein are included in the implementations.

While the foregoing disclosure shows illustrative implementations of the technology disclosed herein, it should be noted that various changes and modifications could be made herein without departing from the scope of the subject matter as defined by the appended claims. The functions, steps, and/or actions of the method claims in accordance with the implementations of the technology described herein need not be performed in any particular order. Furthermore, although elements of the implementations of the technology disclosed herein may be described or claimed in the singular, the plural is contemplated unless limitation to the singular is explicitly stated.

What is claimed is:

1. A method for routing a coherence request to one or more caches in a computing system, the method comprising:
determining one or more transaction attributes for a cache coherence transaction from a requesting processor;
identifying a cachability domain and/or shareability domain based on the transaction attributes; and
routing the cache coherence transaction to one or more caches in the cachability domain and/or shareability domain.

2. The method of claim 1, wherein the one or more transaction attributes includes an address space identifier (ASID).

3. The method of claim 1, wherein the one or more transaction attributes includes a virtual machine identifier (VMID).

4. The method of claim 1, wherein the one or more transaction attributes includes a secure root identifier (NS).

5. The method of claim 1, wherein the one or more transaction attributes includes a hypervisor identifier (HYP).

6. The method of claim 1, wherein the one or more transaction attributes includes at least two selected from the group consisting of: an address space identifier (ASID), a virtual machine identifier (VMID), a secure root identifier (NS), and a hypervisor identifier (HYP) for the requesting processor.

7. The method of claim 1, wherein the requesting processor is a Graphics Processing Unit (GPU) or a Digital Signal Processor (DSP).

8. An apparatus for routing a coherence request to one or more caches in a computing system, the apparatus comprising:
a memory management unit (MMU) configured to determine one or more transaction attributes for a cache coherence transaction from a requesting processor; and
a routing module configured to:
identify a cachability domain and/or shareability domain based on the transaction attributes and to route the cache coherence transaction to one or more caches in the cachability domain and/or shareability domain.

9. The apparatus of claim 8, wherein the one or more transaction attributes includes an address space identifier (ASID).

10. The apparatus of claim 8, wherein the one or more transaction attributes includes a virtual machine identifier (VMID).

11. The apparatus of claim 8, wherein the one or more transaction attributes includes a secure root identifier (NS).

12. The apparatus of claim 8, wherein the one or more transaction attributes includes a hypervisor identifier (HYP).

13. The apparatus of claim 8, wherein the one or more transaction attributes includes at least two selected from the group consisting of: an address space identifier (ASID), a virtual machine identifier (VMID), a secure root identifier (NS), and a hypervisor identifier (HYP) for the requesting processor.

14. The apparatus of claim 8, wherein the requesting processor is a Graphics Processing Unit (GPU) and a Digital Signal Processor (DSP).

15. The apparatus of claim 8, wherein the requesting processor is integrated in an integrated circuit.

16. The apparatus of claim 15, wherein the integrated circuit is integrated into a device selected from the group consisting of: a set-top box, music player, video player, entertainment unit, navigation device, communications device, personal digital assistant (PDA), fixed location data unit, and a computer.

17. An apparatus for routing a coherence request to one or more caches in a computing system, the apparatus comprising:
means for determining one or more transaction attributes for a cache coherence transaction from a requesting processor;
means for identifying a cachability domain and/or shareability domain based on the transaction attributes; and
means for routing the cache coherence transaction to one or more caches in the cachability domain and/or shareability domain.

18. The apparatus of claim 17, wherein the one or more transaction attributes includes an address space identifier (ASID).

19. The apparatus of claim 17, wherein the one or more transaction attributes includes a virtual machine identifier (VMID).

20. The apparatus of claim 17, wherein the one or more transaction attributes includes a secure root identifier (NS).

21. The apparatus of claim 17, wherein the one or more transaction attributes includes a hypervisor identifier (HYP).

22. The apparatus of claim 17, wherein the one or more transaction attributes includes at least two selected from the group consisting of: an address space identifier (ASID), a virtual machine identifier (VMID), a secure root identifier (NS), and a hypervisor identifier (HYP) for the requesting processor.

23. The apparatus of claim 17, wherein the requesting processor is a Graphics Processing Unit (GPU) or a Digital Signal Processor (DSP).

24. The apparatus of claim 17, wherein the requesting processor is integrated in an integrated circuit.

25. The apparatus of claim 24, wherein the integrated circuit is integrated into a device selected from the group consisting of: a set-top box, music player, video player, entertainment unit, navigation device, communications device, personal digital assistant (PDA), fixed location data unit, and a computer.

26. A computer-readable storage medium including information that, when accessed by a machine, cause the machine to perform operations for routing a coherence request to one or more caches in a computing system, the operations comprising:
determining one or more transaction attributes for a cache coherence transaction from a requesting processor;
identifying a cachability domain and/or shareability domain based on the transaction attributes; and
routing the cache coherence transaction to one or more caches in the cachability domain and/or shareability domain.

27. The computer-readable storage medium of claim 26, wherein the one or more transaction attributes includes at least one of an address space identifier (ASID) and a virtual machine identifier (VMID).

28. The computer-readable storage medium of claim 26, wherein the one or more transaction attributes includes at least one of a secure root identifier (NS) and a hypervisor identifier (HYP).

29. The computer-readable storage medium of claim 26, wherein the one or more transaction attributes includes at least two selected from the group consisting of: an address space identifier (ASID), a virtual machine identifier (VMID), a secure root identifier (NS), and a hypervisor identifier (HYP) for the requesting processor.

30. The computer-readable storage medium of claim 26, wherein the requesting processor is a Graphics Processing Unit (GPU) or a Digital Signal Processor (DSP).
